(19) United States
(12) Patent Application Publication
(10) Pub. No.: US 2017/0285238 A1
(43) Pub. Date: Oct. 5, 2017

(54) OPTICAL ISOLATOR

(71) Applicant: Intel Corporation, Santa Clara, CA (US)

(72) Inventors: Arnon Hirshberg, D.N Misgav (IL); Barak Freedman, Yokneam (IL); Nikolai Berkovitch, Haifa (IL)

(73) Assignee: Intel Corporation, Santa Clara, CA (US)

(21) Appl. No.: 15/086,709

(22) Filed: Mar. 31, 2016

(51) Int. Cl. G02B 5/30; G02B 27/28; H04N 3/08; G02B 26/08

(52) U.S. Cl. CPC G02B 5/3083; G02B 26/0833; G02B 27/283; H04N 3/08

(57) ABSTRACT

An optical assembly including a polarizing beam splitter (PBS) to receive a laser beam from a light source. A micro-electro-mechanical systems (MEMS) mirror disposed in a support structure of the assembly, wherein the MEMS mirror is rotatable and is configured to receive the laser beam from the PBS and to reflect an exit beam. A phase retardation layer deposited on the MEMS mirror.

### TECHNICAL FIELD

The present techniques relate generally to optical isolators, and more particularly, to an embedded microelectromechanical system (MEMS) optical isolator.

### BACKGROUND ART

A factor in optoelectronic systems, such as laser scanners, projectors, and other laser devices, is an allowed field of view (FOV) of a controlled deflection of laser beams, provided by scanning mirrors in the system. The FOV may be impacted by the mechanical form factor or physical dimensions of the system. For example, laser projector units embedded in mobile devices may have size constraints in order to fit into the mobile devices. On the other hand, it may be desirable to have the projector units with a relatively large FOV because of the short use distances of projector units, e.g., in the mobile devices. The design may involve a combination of a small form factor and large form factor. Therefore, micro-electro-mechanical systems (MEMS) scanning mirrors may be employed. Laser devices such as projector units with MEMS scanning mirrors may be utilized.

### BRIEF DESCRIPTION OF DRAWINGS

FIG. 1 is a diagram of an optical system.

FIG. 2 is a diagram of an optical system in accordance with embodiments of the present techniques.

FIG. 3 is a block diagram an electronic device in accordance with embodiments of the present techniques.

FIG. 4 is a block diagram of a method of manufacturing an optical system in accordance with embodiments of the present techniques.

FIG. 5 is a block diagram of a method of operating an optical system in accordance with embodiments of the present techniques.

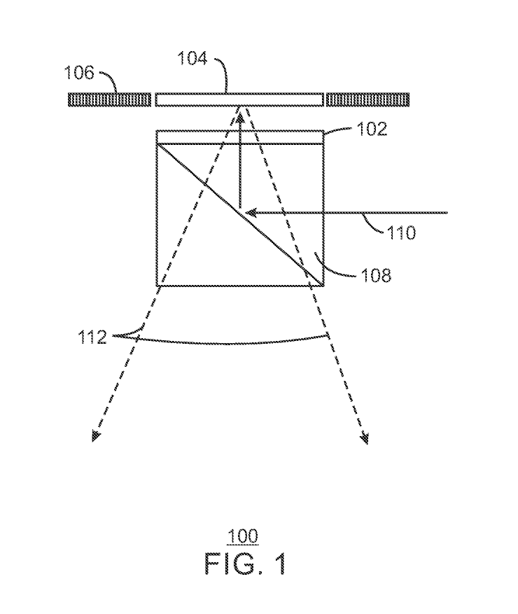

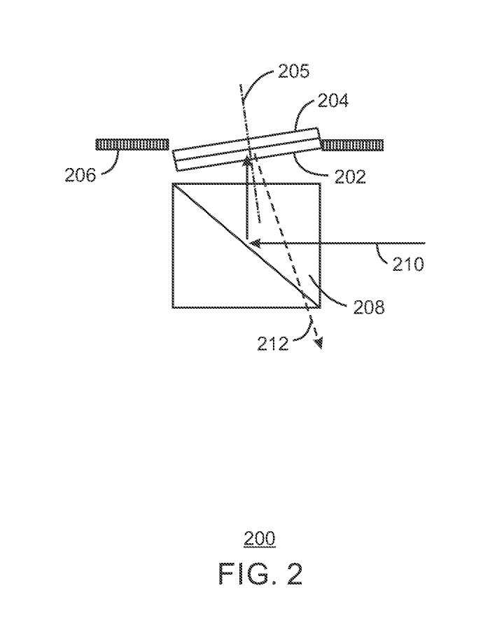

The same numbers are used throughout the disclosure and the figures to reference like components and features. Numbers in the 100 series refer to features originally found in FIG. 1; numbers in the 200 series refer to features originally found in FIG. 2; and so on.

### DETAILED DESCRIPTION

The present techniques relate generally to an optical assembly having a light sources and a polarizing beam splitter (PBS) that receives a laser beam from the light source. The optical assembly has a micro-electro-mechanical systems (MEMS) mirror disposed in a support structure, wherein the MEMS mirror is rotatable, and receives the laser beam from the PBS and reflects an exit beam. A phase retardation layer is deposited on the MEMS mirror.

In order to build a small optical assembly for a laser projector having a field of view, a polarizing beam splitter optical assembly may be used. See U.S. Patent Publication No. US 2014/0253992 “MEMS Scanning Mirror Field of View Provision Methods and Apparatuses” which is incorporated by reference herein in its entirety for all purposes. An optoelectronic assembly may include a MEMS scanning mirror. The MEMS scanning mirror may be a micro-scale mirror rotatable to deflect an incident light beam into an exit window of the optoelectronic assembly. A support structure may host the mirror to provide a light delivery field between a mirror surface and the exit window such that a path of the deflected light beam via the provided light delivery field to the exit window is un-obstructed.

In order to compact a projector optical assembly, a polarizing beam splitter (PBS) and a retardation plate (e.g., a quarter wave plate or QWP) that acts as an optical isolator may be employed. The incoming polarized beam is diverged by the PBS through a retardation plate (QWP) to a scanning mirror. The mirror reflects the beam back through the QWP and the PBS. The reflected beam polarization is changed by the QWP and the PBS passes the beam. Certain embodiments herein are directed to the QWP deposition on the mirror.

One solution may be to fabricate a discreet QWP “window” and bond it to a beam splitter. In contrast, certain embodiments herein apply the QWP layer on one of the existing components such as on the mirror. An advantage of applying the retardation or QWP layer on the mirror may be optical efficiency in that the entry and exit angles to the QWP are identical or near identical, improving polarization rotation. Conversely, if QWP is a discreet component, an entry beam is perpendicular to the QWP and exit angles follow the scanning mirror. Another advantage of depositing the retardation plate on the mirror may be reduced cost and complexity. The bonding of a discreet QWP to a PBS may use thin layer handling and high assembly tolerances which makes the fabrication costly. Thus, using a mass production, wafer level QWP layer with respect to the mirror may simplify the fabrication and result in cost reduction. The QWP layer may be a few micrometers versus hundreds of micrometers in discreet QWP thickness.

A polarizing beam splitter may facilitate “head on” beam incidence onto the MEMS mirror, and a phase retardation plate to rotate the beam polarization so the beam exits the mirror in the correct direction, and not reflected back into the laser source. This technique uses a polarized light source. A shallow mechanical setup (laser source and optics flat with the mirror) and steep beam incidence angle may address the problem of the mirror perimeter blocking parts of the beam in large scan angles. In some embodiments, no change to mirror design is required, but a change to the overall optical system design is implemented.

FIG. 1 is an optical system 100 which may be employed as an optical isolator and in a laser system, optical laser projector, 3D camera, computing device, and so forth. The optical system 100 has a phase retardation plate 102. The phase retardation plate 102 may be a quarter wave plate (QWP). A micro-electro-mechanical systems (MEMS) mirror 104 is disposed in a support frame 106. The retardation plate 102 is disposed on a polarizing beam splitter (PBS) 108. The retardation plate 102 may be bonded to the PBS 108. Indeed, in the illustrated example of FIG. 1, a discreet retardation plate 102 is bonded to the PBS 108. In operation, an incoming laser beam 110 passes through the PBS 108 entering the retardation plate 102 perpendicularly. The exit beams 112 reflected from the MEMS mirror 104 enter the retardation plate 102 at an angle impacted by the mirror 104 tilt. The difference in angles of the exit beams 112 and incoming beam 110 with respect to the retardation plate 102 may adversely affect the retardation efficiency.

FIG. 2 is an optical system 200 which may be employed as an optical isolator and in a laser system, optical laser projector, 3D camera, computing device (e.g., tablet, smartphone, desktop, laptop, etc.), and so forth. The optical system 200 has a phase retardation plate 202 fabricated on a MEMS mirror 204. The phase retardation plate 202 may be a quarter wave plate (QWP). The MEMS mirror 204 may be rotatable and disposed in a support frame 206. The optical system 200 includes a PBS 208. In operation, with the retardation plate 202 fabricated on the mirror 204, an incoming laser beam 210 passes through the PBS 208 entering the retardation plate 202 at the mirror 204 tilt angle.

The exit beam 212 (with rotated polarization) reflects from the mirror 204 at the same angle relative to the normal axis 205 of the mirror 204, as the angle of the incoming beam 210 with respect to the normal axis 205. When the entering beam 210 and the exit beam 212 are at the same angle with respect to the normal axis 205 of the mirror 204 and the retardation plate 202, the retardation efficiency may be increased. By applying the phase retardation layer (retardation plate 202) to the mirror 204 during MEMS fabrication, the assembly (system 200) may become simpler and less expensive, and the polarization efficiency increased.

The technique may be based on turning linear polarization into circular polarization and back. If light passes through the retardation plate or QWP in the same angles, the polarization rotation may be increased or optimal. If the QWP is not deposited on the mirror, light will pass in one angle, and exit in a different angle, due to mirror scanning. This is generally not optimal for polarization rotation. Conversely, embodiments herein deposit (e.g., at the wafer level) a commercial material to the mirror to perform the retardation function. The deposition may be spin coating on wafer, for example. The optical assembly 200 of FIG. 2 may be or include an optical isolator, and in particular, may be or include a MEMS optical isolator.

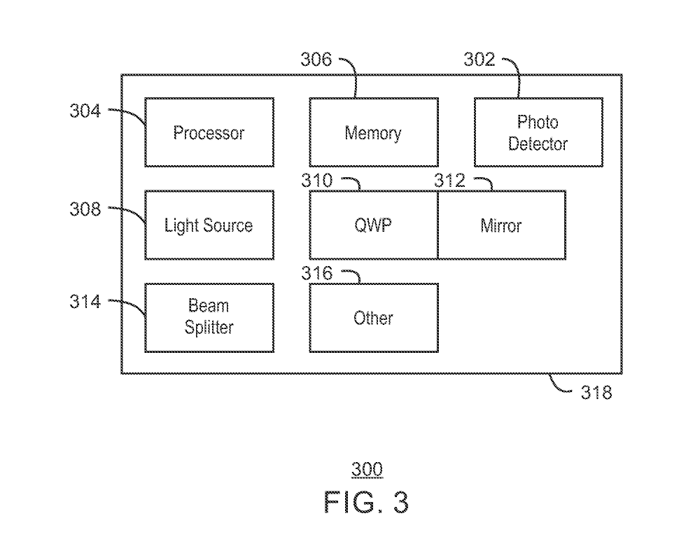

FIG. 3 is an electronic device 300 (e.g., computer, laser projector, etc.) having an optical system including a photo detector 302. The device 300 may include a processor 304 (e.g., central processing unit or CPU) and memory 306. The memory 306 may include nonvolatile memory and volatile memory. Of course, the optical system or laser projector 300 may include a light source 308 (e.g., with collimated optics). Further, as indicated above with respect to FIG. 2, the optical system or laser projector 300 may include a phase retardation layer or plate 310 (e.g., QWP) deposited on a MEMS mirror 312. The device 300 may include a PBS 314 and other components 316. One or more of the aforementioned items may be disposed in a housing 318. While all of the aforementioned items are depicted within the housing 318, in other examples, some of the items may be outside the housing 318, such as in a different housing or disposition of the device 300.

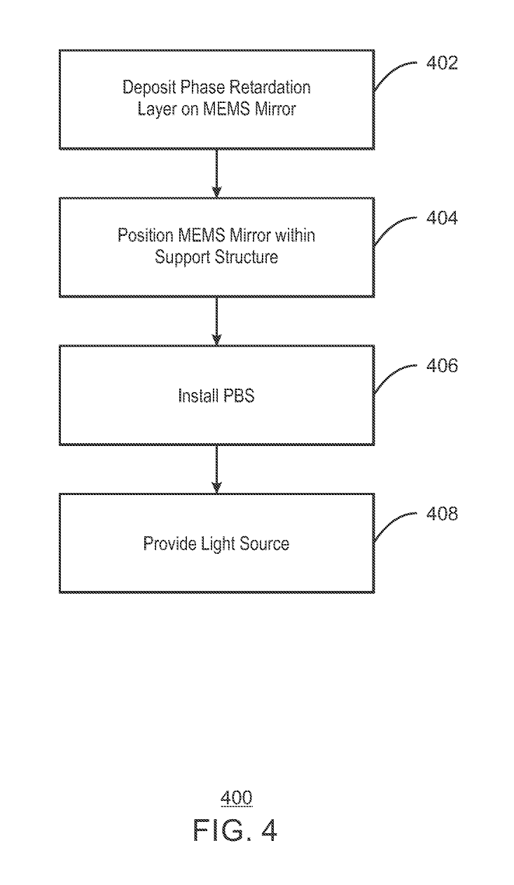

FIG. 4 is a method 400 of fabricating an optical system. At block 402, a phase retardation layer is deposited (e.g., at the wafer level) on a MEMS mirror. The phase retardation layer may be a QWP material, for example. The deposition may be spin coating on wafer, for instance. At block 404, the MEMS mirror with the deposited phase retardation layer is positioned within a support structure of the optical system. At block 406, a PBS is installed, such that the PBS will be adjacent the MEMS mirror having the deposited phase retardation layer. At block 408, a laser source or light source with collimated optics is provided such that a light beam or laser beam can be provided to the PBS in operation, and the light beam passing through the PBS reflected from the MEMS mirror and impacted by the phase retardation layer. In examples, the reflected laser beam is an exit beam reflected from the MEMS mirror with rotated polarization.

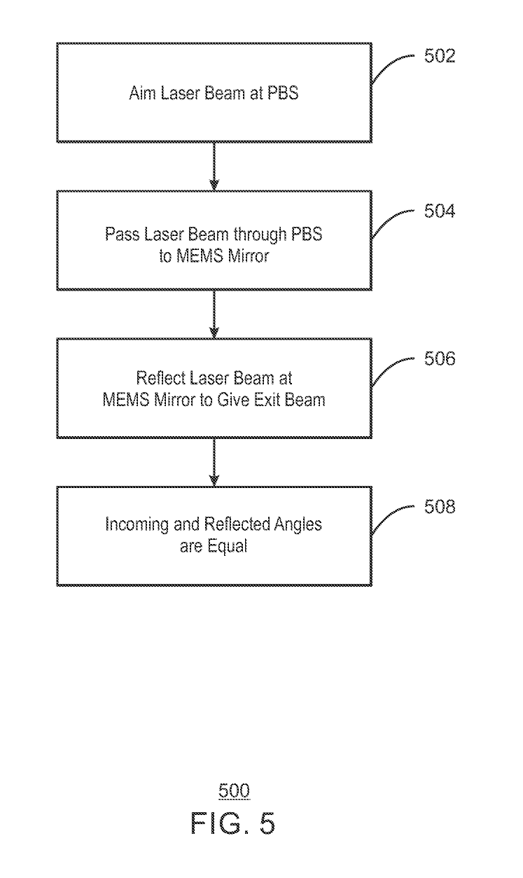

FIG. 5 is a method 500 of operating an optical system. At block 502, a laser is aimed at a PBS. Thus, the PBS receives an incoming laser beam. At block 504, the PBS passes the laser beam to a MEMS mirror having a phase retardation layer deposited thereon (e.g., spin coated at the wafer level). The phase retardation layer may be a QWP material, for example. In operation, when receiving the laser beam from the PBS, the MEMS mirror having the deposited phase retardation layer may be tilted or rotated. The MEMS mirror and phase retardation layer receives the laser at a first angle with respect to a normal axis of the mirror and phase retardation layer. At block 506, the MEMS mirror with the deposited phase retardation layer reflects the laser beam giving an exit beam at a second angle with respect to the normal axis of the mirror and phase retardation layer. The reflected exit beam may have a rotated polarization. As noted in block 508, for some embodiments, the first angle and the second angle are equal. Such may increase retardation efficiency.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment”, “one embodiment”, “some embodiments”, “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

Examples are given. Example 1 is an optical assembly. The optical assembly includes a polarizing beam splitter (PBS) configured to receive a laser beam from a light source; a micro-electro-mechanical systems (MEMS) mirror disposed in a support structure, wherein the MEMS mirror is rotatable and is configured to receive the laser beam from the PBS and to reflect an exit beam; and a phase retardation layer deposited on the MEMS mirror.

Example 2 includes the optical assembly of example 1, including or excluding optional features. In this example, the phase retardation layer comprises a quarter wave plate (QWP).

Example 3 includes the optical assembly of any one of examples 1 to 2, including or excluding optional features. In this example, the phase retardation layer is not discrete but is spin-coated deposited onto the MEMS mirror at a wafer level.

Example 4 includes the optical assembly of any one of examples 1 to 3, including or excluding optional features. In this example, the MEMS mirror is configured to receive the laser beam at a first angle with respect to a normal axis of the MEMS mirror and the phase retardation layer; and the MEMS mirror is configured to reflect the laser beam at a second angle with respect to the normal axis of the MEMS mirror and the phase retardation layer, and wherein the first angle is equal to the second angle.

Example 5 includes the optical assembly of any one of examples 1 to 4, including or excluding optional features. In this example, the exit beam comprises a rotated polarization.

Example 6 includes the optical assembly of any one of examples 1 to 5, including or excluding optional features. In this example, the optical assembly includes the light source, wherein the light source comprises collimated optics.

Example 7 is an electronic device. The electronic device includes a processor and memory; and an optical assembly comprising: a light source with collimated optics; a polarizing beam splitter (PBS) configured to receive a laser beam from the light source; a micro-electro-mechanical systems (MEMS) mirror disposed in a support structure, wherein the MEMS mirror is rotatable and is configured to receive the laser beam from the PBS and to reflect an exit beam; and a phase retardation layer deposited on the MEMS mirror, wherein the exit beam comprises a rotated polarization.

Example 8 includes the electronic device of example 7, including or excluding optional features. In this example, the phase retardation layer comprises a quarter wave plate (QWP).

Example 9 includes the electronic device of any one of examples 7 to 8, including or excluding optional features. In this example, the phase retardation layer is not discrete but is spin-coated deposited onto the MEMS mirror at a wafer level.

Example 10 includes the electronic device of any one of examples 7 to 9, including or excluding optional features. In this example, the MEMS mirror is configured to receive the laser beam at a first angle with respect to a normal axis of the MEMS mirror and the phase retardation layer; and the MEMS mirror is configured to reflect the laser beam at a second angle with respect to the normal axis of the MEMS mirror and the phase retardation layer, and wherein the first angle is equal to the second angle.

Example 11 includes the electronic device of any one of examples 7 to 10, including or excluding optional features. In this example, the electronic device comprises a computing device.

Example 12 is a method of manufacturing an optical system. The method includes depositing a phase retardation layer on a micro-electro-mechanical systems (MEMS) mirror; disposing the MEMS mirror having the phase retardation layer in a support structure to receive a laser beam from a polarizing beam splitter (PBS) and to reflect an exit beam having a rotated polarization; and disposing the PBS to receive the laser beam from a light source and to provide the laser beam to the MEMS mirror having the phase retardation layer;

Example 13 includes the method of example 12, including or excluding optional features. In this example, the phase retardation layer comprises a quarter wave plate (QWP).

Example 14 includes the method of any one of examples 12 to 13, including or excluding optional features. In this example, the phase retardation layer is not discrete and wherein depositing comprises spin-coating the phase retardation layer onto the MEMS mirror at a wafer level.

Example 15 includes the method of any one of examples 12 to 14, including or excluding optional features. In this example, the MEMS mirror is configured to receive the laser beam at a first angle with respect to a normal axis of the MEMS mirror and the phase retardation layer; and the MEMS mirror is configured to reflect the laser beam at a second angle with respect to the normal axis of the MEMS mirror and the phase retardation layer, and wherein the first angle and the second angle are the same value.

Example 16 includes the method of any one of examples 12 to 15, including or excluding optional features. In this example, the method includes providing the light source.

Example 17 is a method of operating an optical system. The method includes providing a laser beam from a light source to a polarizing beam splitter (PBS); passing the laser beam through the PBS to a micro-electro-mechanical systems (MEMS) mirror, the MEMS mirror having a phase retardation layer deposited thereon; and reflecting, via the MEMS mirror, an exit beam through the deposited phase retardation layer, the exit beam having a rotated polarization.

Example 18 includes the method of example 17, including or excluding optional features. In this example, the phase retardation layer comprises a quarter wave plate (QWP).

Example 19 includes the method of any one of examples 17 to 18, including or excluding optional features. In this example, the phase retardation layer is not discrete and wherein the phase retardation layer is deposited onto the MEMS mirror at a wafer level.

Example 20 includes the method of any one of examples 17 to 19, including or excluding optional features. In this example, the MEMS mirror receives the laser beam at a first angle with respect to a normal axis of the MEMS mirror and the phase retardation layer; and the MEMS mirror reflects the laser beam at a second angle with respect to the normal axis of the MEMS mirror and the phase retardation layer, and wherein the first angle and the second angle are the same value.

Example 21 is an optical assembly. The optical assembly includes a polarizing beam splitter (PBS) configured to receive a laser beam from a light source with collimated optics; a micro-electro-mechanical systems (MEMS) mirror disposed in a support structure, wherein the MEMS mirror is rotatable and is configured to receive the laser beam from the PBS and to reflect an exit beam comprising a rotated polarization; and a phase retardation layer deposited on the MEMS mirror.

Example 22 includes the optical assembly of example 21, including or excluding optional features. In this example, the phase retardation layer comprises a quarter wave plate (QWP).

Example 23 includes the optical assembly of any one of examples 21 to 22, including or excluding optional features. In this example, the phase retardation layer is not discrete but is spin-coated deposited onto the MEMS mirror at a wafer level.

Example 24 includes the optical assembly of any one of examples 21 to 23, including or excluding optional features. In this example, the MEMS mirror is configured to receive the laser beam at a first angle with respect to a normal axis of the MEMS mirror and the phase retardation layer; and the MEMS mirror is configured to reflect the laser beam at a second angle with respect to the normal axis of the MEMS mirror and the phase retardation layer, and wherein the first angle is equal to the second angle.

Example 25 is a computing device. The computing device includes a processor and memory; and an optical assembly comprising: a light source with collimated optics; a polarizing beam splitter (PBS) configured to receive a laser beam from the light source; a micro-electro-mechanical systems (MEMS) mirror disposed in a support structure, wherein the MEMS mirror is rotatable and is configured to receive the laser beam from the PBS and to reflect an exit beam; and a phase retardation layer deposited on the MEMS mirror, wherein the exit beam comprises a rotated polarization.

Example 26 includes the computing device of example 25, including or excluding optional features. In this example, the phase retardation layer comprises a quarter wave plate (QWP).

Example 27 includes the computing device of any one of examples 25 to 26, including or excluding optional features. In this example, the phase retardation layer is not discrete but is spin-coated deposited onto the MEMS mirror at a wafer level.

Example 28 includes the computing device of any one of examples 25 to 27, including or excluding optional features. In this example, the MEMS mirror is configured to receive the laser beam at a first angle with respect to a normal axis of the MEMS mirror and the phase retardation layer; and the MEMS mirror is configured to reflect the laser beam at a second angle with respect to the normal axis of the MEMS mirror and the phase retardation layer, and wherein the first angle is equal to the second angle.

Example 29 is a method of manufacturing an optical system. The method includes depositing a phase retardation layer on a micro-electro-mechanical systems (MEMS) mirror; disposing the MEMS mirror having the phase retardation layer in a support structure to receive a laser beam from a polarizing beam splitter (PBS) and to reflect an exit beam having a rotated polarization; disposing the PBS to receive the laser beam from a light source and to pass the laser beam to the MEMS mirror having the phase retardation layer, wherein the light source comprises collimated optics;

Example 30 includes the method of example 29, including or excluding optional features. In this example, the phase retardation layer comprises a quarter wave plate (QWP).

Example 31 includes the method of any one of examples 29 to 30, including or excluding optional features. In this example, the phase retardation layer is not discrete and wherein depositing comprises spin-coating the phase retardation layer onto the MEMS mirror at a wafer level.

Example 32 includes the method of any one of examples 29 to 31, including or excluding optional features. In this example, the MEMS mirror is configured to receive the laser beam at a first angle with respect to a normal axis of the MEMS mirror and the phase retardation layer; and the MEMS mirror is configured to reflect the laser beam at a second angle with respect to the normal axis of the MEMS mirror and the phase retardation layer, and wherein the first angle and the second angle are the same value.

Example 33 includes the method of any one of examples 29 to 32, including or excluding optional features. In this example, the method includes providing the light source.

Example 34 is a method of operating an optical system. The method includes aiming a laser beam from a light source at a polarizing beam splitter (PBS), wherein the light source comprises collimated optics; passing the laser beam through the PBS to a micro-electro-mechanical systems (MEMS) mirror, the MEMS mirror having a phase retardation layer; and reflecting an exit beam from the MEMS mirror though the phase retardation layer, wherein the exit bean comprises a rotated polarization.

Example 35 includes the method of example 34, including or excluding optional features. In this example, the phase retardation layer comprises a quarter wave plate (QWP) deposited on the MEMS mirror.

Example 36 includes the method of any one of examples 34 to 35, including or excluding optional features. In this example, the phase retardation layer is not discrete and wherein the phase retardation layer is deposited onto the MEMS mirror at a wafer level.

Example 37 includes the method of any one of examples 34 to 36, including or excluding optional features. In this example, the MEMS mirror receives the laser beam at a first angle with respect to a normal axis of the MEMS mirror and the phase retardation layer; and the MEMS mirror reflects the laser beam at a second angle with respect to the normal axis of the MEMS mirror and the phase retardation layer, and wherein the first angle and the second angle are the same value.

It is to be understood that specifics in the aforementioned examples may be used anywhere in one or more embodiments. For instance, all optional features of the computing device described above may also be implemented with respect to either of the methods described herein or a computer-readable medium. Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

1. An optical assembly comprising:
a polarizing beam splitter (PBS) configured to receive a laser beam from a light source;
a micro-electro-mechanical systems (MEMS) mirror disposed in a support structure, wherein the MEMS mirror is rotatable and is configured to receive the laser beam from the PBS and to reflect an exit beam; and
a phase retardation layer deposited on the MEMS mirror.

2. The optical assembly of claim 1, wherein the phase retardation layer comprises a quarter wave plate (QWP).

3. The optical assembly of claim 1, wherein the phase retardation layer is not discrete but is spin-coated deposited onto the MEMS mirror at a wafer level.

4. The optical assembly of claim 1, wherein:
the MEMS mirror is configured to receive the laser beam at a first angle with respect to a normal axis of the MEMS mirror and the phase retardation layer; and
the MEMS mirror is configured to reflect the laser beam at a second angle with respect to the normal axis of the MEMS mirror and the phase retardation layer, and wherein the first angle is equal to the second angle.

5. The optical assembly of claim 1, wherein the exit beam comprises a rotated polarization.

6. The optical assembly of claim 1, comprising the light source, wherein the light source comprises collimated optics.

7. An electronic device comprising:
a processor and memory; and
an optical assembly comprising:
a light source with collimated optics;
a polarizing beam splitter (PBS) configured to receive a laser beam from the light source;
a micro-electro-mechanical systems (MEMS) mirror disposed in a support structure, wherein the MEMS mirror is rotatable and is configured to receive the laser beam from the PBS and to reflect an exit beam; and
a phase retardation layer deposited on the MEMS mirror, wherein the exit beam comprises a rotated polarization.

8. The electronic device of claim 7, wherein the phase retardation layer comprises a quarter wave plate (QWP).

9. The electronic device of claim 7, wherein the phase retardation layer is not discrete but is spin-coated deposited onto the MEMS mirror at a wafer level.

10. The electronic device of claim 7, wherein:
the MEMS mirror is configured to receive the laser beam at a first angle with respect to a normal axis of the MEMS mirror and the phase retardation layer; and
the MEMS mirror is configured to reflect the laser beam at a second angle with respect to the normal axis of the MEMS mirror and the phase retardation layer, and wherein the first angle is equal to the second angle.

11. The electronic device of claim 7, wherein the electronic device comprises a computing device.

12. A method of manufacturing an optical system, comprising:
depositing a phase retardation layer on a micro-electro-mechanical systems (MEMS) mirror;
disposing the MEMS mirror having the phase retardation layer in a support structure to receive a laser beam from a polarizing beam splitter (PBS) and to reflect an exit beam having a rotated polarization; and
disposing the PBS to receive the laser beam from a light source and to provide the laser beam to the MEMS mirror having the phase retardation layer;

13. The method of claim 12, wherein the phase retardation layer comprises a quarter wave plate (QWP).

14. The method of claim 12, wherein the phase retardation layer is not discrete and wherein depositing comprises spin-coating the phase retardation layer onto the MEMS mirror at a wafer level.

15. The method of claim 12, wherein:
the MEMS mirror is configured to receive the laser beam at a first angle with respect to a normal axis of the MEMS mirror and the phase retardation layer; and
the MEMS mirror is configured to reflect the laser beam at a second angle with respect to the normal axis of the MEMS mirror and the phase retardation layer, and wherein the first angle and the second angle are the same value.

16. The optical method of claim 12, comprising providing the light source.

17. A method of operating an optical system, comprising:
providing a laser beam from a light source to a polarizing beam splitter (PBS);
passing the laser beam through the PBS to a micro-electro-mechanical systems (MEMS) mirror, the MEMS mirror having a phase retardation layer deposited thereon; and
reflecting, via the MEMS mirror, an exit beam through the deposited phase retardation layer, the exit beam having a rotated polarization.

18. The method of claim 17, wherein the phase retardation layer comprises a quarter wave plate (QWP).

19. The method of claim 17, wherein the phase retardation layer is not discrete and wherein the phase retardation layer is deposited onto the MEMS mirror at a wafer level.

20. The method of claim 17, wherein:
the MEMS mirror receives the laser beam at a first angle with respect to a normal axis of the MEMS mirror and the phase retardation layer; and
the MEMS mirror reflects the laser beam at a second angle with respect to the normal axis of the MEMS mirror and the phase retardation layer, and wherein the first angle and the second angle are the same value.
